(19) United States
(12) Patent Application Publication
(10) Pub. No.: US 2026/0078468 A1
(43) Pub. Date: Mar. 19, 2026

(54) Recycling Of Nickel And/Or Lithium From Spent Cathodes Forming Battery Grade Material

(71) Applicant: Xera Energy Inc., Fremont, CA (US)

(72) Inventors: Haixia Deng, Fremont, CA (US); Junchao Liu, Newark, NJ (US)

(21) Appl. No.: 19/330,674

(22) Filed: Sep. 16, 2025

Related U.S. Application Data
(60) Provisional application No. 63/695,523, filed on Sep. 17, 2024.
(60) Provisional application No. 63/728,565, filed on Dec. 5, 2024.

(51) Int. Cl. C22B 3/00; C01D 15/08; C01F 7/02; C01G 49/02; C01G 53/05; C22B 3/38; C22B 7/00; C22B 15/00; C22B 21/00; C22B 26/12; C22B 47/00; C25C 1/08; H01M 10/54

(52) U.S. Cl. CPC C22B 23/0484; C01D 15/08; C01F 7/02; C01G 49/02; C01G 53/05; C22B 3/3842; C22B 7/007; C22B 15/0071; C22B 15/0089; C22B 21/0023; C22B 23/043; C22B 23/0453; C22B 26/12; C22B 47/00; C25C 1/08; H01M 10/54; C01P 2006/80

(57) ABSTRACT

A method provides for separating nickel from an aqueous solution using an organic—aqueous extraction by performing one or more liquid-liquid extraction stages performed using an input aqueous solution comprising lithium ions, nickel ions, and cobalt ions and/or manganese ions, wherein each extraction stage comprises mixing an aqueous phase with dissolved metal sulfate with an organic solvent having dissolved di-(2,4,4-trimethylpentyl) phosphinic acid from 30% to 70% hydroxyl saponified with alkali, NH₄⁺ or nickel counter ions. A collected purified aqueous phase comprising at least 90% of the nickel from the input aqueous solution and no more than about 5% of the each of the cobalt and manganese. The input aqueous solution is prepared from recovered lithium ion battery material.

### CROSS REFERENCE TO RELATED APPLICATIONS

This application claims priority to copending U.S. provisional patent applications 63/695,523 filed Sep. 17, 2024 to Deng, entitled “Recycling of Nickel from Spent Cathodes Forming Battery Grade Material,” and 63/728,565 filed Dec. 5, 2024 to Deng, et al. entitled “Recycling of Nickel and/or Lithium from Spent Cathodes Forming Battery Grade Material,” both of which are incorporated herein by reference.

### BACKGROUND OF THE INVENTION

With the steady shift to electric vehicles and other forms of electrification to mitigate further contributions of carbon dioxide into the atmosphere, there is a growing demand for lithium-ion batteries to power these electric vehicles. This global focus on sustainability, electrification is accelerating demand for critical minerals. However, natural resources are limited and depleting, while discarded end-of-life EV batteries contribute to resource loss, pollution, and economic waste. Additionally, the U.S. and Europe lack sufficient infrastructure to support a circular economy, resulting in reliance on foreign sources and increased supply chain risks, which disrupt global relations and power dynamics. Researchers and industries are actively seeking feasible methods to recycle lithium-ion batteries and reintegrate them into the energy supply chain to address these challenges. Current method typically involves traditional solvent extraction that involves a large number of process steps and very capital intensive equipment.

### SUMMARY OF THE INVENTION

In a first aspect, the invention pertains to a method for separating nickel from an aqueous solution using an organic—aqueous extraction comprising:
performing one or more liquid-liquid extraction stages performed using an input aqueous
solution comprising lithium ions, nickel ions, and cobalt ions and/or manganese ions; and
collecting a purified aqueous phase comprising at least 90% of the nickel from the input aqueous solution and no more than about 5% of the each of the cobalt and manganese from the input aqueous solution and other elements, except Li⁺, Na⁺, NH₄⁺.

Each liquid-liquid extraction stage generally comprises:
mixing an aqueous phase with dissolved metal sulfate with an organic solvent, wherein the organic solvent has a density no greater than 0.975 g/mL, has a volume from about 0.1 times to about 50 times the aqueous volume, and wherein the organic phase comprises di-(2,4,4-trimethylpentyl) phosphinic acid from 30% to 70% hydroxyl saponified with alkali, NH₄⁺ or nickel counter ions; and
separating the organic phase from the aqueous phase to extract cobalt ions and manganese ions from the aqueous phase while maintaining nickel substantially in the aqueous phase.

In some embodiments, the organic solvent comprises mineral oils, kerosene, sulphonated kerosene or mixtures thereof. The organic phase can have a concentration of di-(2,4,4-trimethylpentyl) phosphinic acid from about 2 vol % to about 25 vol %, and the di-(2,4,4-trimethylpentyl) phosphinic acid can be 45% to 65% saponified. The saponification may involve nickel+2 ions, and/or sodium +1 ions, and/or NH₄⁺ ions. In some embodiments, the separating step further extracts Al, Fe, Cu, Zn, Mg, and/or Ca ions into the organic phase.

For performing the liquid-liquid extraction, the organic phase volume can be from about 0.5 times to about 20 times the aqueous volume. In some embodiments, the liquid-liquid extraction can be performed with a number of stages that is at least 2, and in other embodiments, the extraction is performed with one stage.

In some embodiments, the input aqueous solution comprises at least about 50 wt % nickel relative to the total metal in the solution. The aqueous solution for the extraction input can be obtained from a mass of material from retired lithium ion batteries and/or from nickel ore concentrates. Generally, the input aqueous solution is formed by a process comprising adding sulfuric acid to leach metal from the recovered battery mass, the nickel ore concentrates, or the like to form a leachate. A reducing agent can be added in conjunction with the leaching process to generate metal ions in the +2 oxidation state. In some embodiments, copper, aluminum and iron are removed from the leachate by increasing the pH. In additional or alternative embodiments, copper metal is recovered from the leachate using iron powder as a reducing agent, and iron and aluminum are precipitated as hydroxides using an oxidizing agent and an alkaline additive, while leaving nickel, manganese and cobalt in solution. In another embodiment, small particles larger than micron size, such as Al(OH)₃, Fe(OH)₃, or similar compounds, are added to the aqueous solution (such as recycled material from a previous batch), thereby increasing the particle size of the subsequently precipitated Al(OH)₃ or Fe(OH)₃, which facilitates filtration and removal of these species as impurities.

The method can further comprise precipitating the nickel to obtain nickel hydroxide precipitate, wherein the nickel or the nickel-based hydroxide is in the battery grade and the nickel-based hydroxide is combined with newly added virgin or separately purified elements such as Co, Mn, Al or other elements in an amount from 1% to 50% with doping elements in amounts ranging from a few hundred ppm to a few percent by weight, and with impurity levels of less than 500 ppm by weight. In additional or alternative embodiments, the method can further comprise recovering lithium following precipitation of the nickel. Specifically, the method can further comprise after precipitating nickel, precipitating lithium as a carboxylate. In some embodiments, the method can further comprise recovering manganese and cobalt from the organic phase.

In further aspects, the invention pertains to a further method for recovering purified nickel from a recovered lithium ion battery material, the method comprising:
using precipitation and/or selective leaching, free of any solvent-solvent extractions, of an input aqueous solution to form a prepared solution having greater than about 90 weight %, of the nickel, cobalt and manganese from the input aqueous solution and having no more than about 15 mole % relative to total metal content of iron, copper and aluminum, wherein the input aqueous solution is prepared from recovered lithium ion battery material; and
performing a liquid-liquid extraction with the prepared solution to separate nickel from cobalt and magnesium to obtain a purified aqueous phase comprising at least 90% of the nickel from the input aqueous solution and no more than about 5% of the each of the cobalt and manganese from the input aqueous solution.

The further method can further comprise forming the input aqueous solution using sulfuric acid and an oxidizing agent to dissolve nickel, cobalt and manganese in a +2 oxidation state. The selective leaching can comprise dissolving lithium into an aqueous solution from the recovered lithium ion battery material with a suitable amount of sulfuric acid while retaining most of the nickel, cobalt and manganese in the solid mass.

In some embodiments, the precipitating comprises recovering copper from the input aqueous solution using iron powder to reduce the copper to form a precipitate and filtering the precipitate to isolate the reduced copper as metal. In some embodiments, the precipitating comprises using an alkaline compound and an oxidizing agent to precipitate iron and aluminum as +3 oxidation state hydroxides. The performing of the liquid-liquid extraction can comprise mixing an aqueous phase with dissolved metal sulfate with an organic solvent, wherein the organic solvent has a density no greater than 0.975 g/mL, has a volume from about 0.1 times to about 50 times the aqueous volume, comprises hydrocarbons and wherein the organic phase comprises di-(2,4,4-trimethylpentyl) phosphinic acid from 30% to 70% hydroxyl saponified with alkali, ammonium, and/or nickel counter ions. The organic solvent can comprise mineral oil, kerosene, sulphonated kerosene or a mixture thereof. In some embodiments of the liquid-liquid extraction, the organic phase has a concentration of di-(2,4,4-trimethylpentyl) phosphinic acid from about 2 vol % to about 25 vol %. In some embodiments, the di-(2,4,4-trimethylpentyl) phosphinic acid can be 45% to 65% saponified, wherein the saponification may involve nickel+2 ions, NH₄⁺, sodium+1 ions or a mixture thereof.

For the liquid-liquid extraction of the further method, the organic phase volume can be from about 0.5 times to about 20 times the aqueous volume. The liquid-liquid extraction can comprise one or more stages performed using an input aqueous solution comprising lithium ions, nickel ions, cobalt ions and manganese ions as well as Al, Fe, Cu, Zn, Mg, and/or Ca ions. The number of stages can be at least 2, and in alternative embodiments, the liquid-liquid extraction has one stage with continuous extraction. In some embodiments, each stage of the liquid-liquid extraction can comprise mixing an aqueous phase with dissolved metal sulfate with an organic solvent, wherein the organic solvent has a density no greater than 0.975 g/mL, has a volume from about 0.1 times to about 50 times the aqueous volume, comprises hydrocarbons, and wherein the organic phase comprises di-(2,4,4-trimethylpentyl) phosphinic acid from 30% to 70% hydroxyl saponified with alkali, ammonium or nickel counter ions.

The liquid-liquid extraction of the further method can further comprise separating the organic phase from the aqueous phase to extract cobalt and manganese ions from the aqueous phase while maintaining nickel substantially in the aqueous phase. Additionally or alternatively, the liquid-liquid extract can further comprising collecting a purified aqueous phase comprising at least 90% of the nickel from the input aqueous solution and no more than about 5% of the each of the cobalt and manganese from the input aqueous solution. Furthermore, the further method can further comprise precipitating nickel from the purified aqueous phase, wherein the nickel or the nickel-based hydroxide is in the battery grade and the nickel-based hydroxide is combined with newly added virgin or separately purified elements such as Co, Mn, Al or other elements in an amount from 1% to 50% with doping elements in amounts ranging from a few hundred ppm to a few percent by weight, and with impurity levels of less than 500 ppm by weight.

In an additional or alternative embodiment, previously prepared seed particles larger than micron size are added to the aqueous solution (such as recycled seeds from prior batches), thereby increasing the particle size of the subsequently precipitated nickel hydroxide or nickel-based hydroxide, which facilitates filtration. In another embodiment, new seeds are formed under controlled pH conditions and in the presence of chelating agents such as NH₄OH, with extended reaction times (greater than a few hours) to form regular spherical seeds that can meet customer requests and facilitate filtration. In yet another embodiment, these seeds—either newly formed or grown on previously prepared seeds—are grown into micron-sized secondary particles (approximately 2 μm to 25 μm) suitable for energy applications and beyond.

After precipitating nickel, the method can further comprise precipitating lithium as a carboxylate. In additional or alternative embodiments, the further method can further comprise stripping cobalt and manganese ions into an aqueous phase from loaded organic solvent and coprecipitating cobalt and manganese as hydroxides, carbonates or related compounds together or separately.

### BRIEF DESCRIPTION OF DRAWINGS

FIG. 1 depicts a general procedure describing the overall process for isolation and purification of nickel in the form of nickel hydroxide.

FIG. 2 depicts a general procedure describing optional leaching of a black mass reduction roast leading to recovery of lithium as lithium carbonate.

FIG. 3 depicts a general procedure describing leaching of Ni, Co and Mn to separate inorganic and organic matter of the black mass reduction roast, followed by separation of other ions such as copper, aluminum and iron from the filtrate containing Ni, Co and Mn as sulfates.

FIG. 4A depicts a general procedure describing separation of Ni from Co and Mn ions using the solvent extraction process described herein.

FIG. 4B depicts saponification of an organic phosphinic acid extracting agent with aqueous NaOH.

FIG. 4C depicts nickel saponification of the saponified extracting agent formed as described for FIG. 4B.

FIG. 5 shows a schematic representation of a countercurrent solvent extraction process that can be employed in a large scale operation of the extraction process described herein.

### DETAILED DESCRIPTION

A streamlined approach described herein focuses primarily on the efficient purification of nickel and/or lithium to a battery grade through the avoidance of complicated chemical processes and the huge cost. With the increasing use of nickel-rich active materials for electric vehicle cathodes, particularly in key regions such as the U.S. and Europe, the efficient recovery of battery-grade nickel and/or lithium enables the reintegration of recycled nickel and/or lithium into the production stream, providing a valuable local supply. In some embodiments, the input mass comprises at least about 50 weight percent (wt %) nickel relative to the total amount of metal. While the recovered nickel can be generated in several alternative forms, nickel hydroxide, nickel carbonates or basic nickel carbonates are convenient forms for recovery as well as for reintroduction into the production stream. Various related improvements in the workflow are also introduced in the context of the effective purification of the nickel and/or lithium. In particular, significant purification is performed prior to extraction to separate nickel and/or lithium from cobalt and manganese, the primary metal constituents for the cathode materials of particular interest. In the extraction, an extraction aid, such as Cyanex® 272 (Syensqo), facilitates the transfer of cobalt and manganese into an organic phase for separation from nickel and/or lithium that remain primarily in an aqueous phase. Cyanex® 272 (Syensqo) or generic equivalents can be used as purchased or recycled for reuse after undergoing purification steps such as washing/scrubbing and stripping to remove impurities transferred to the loaded organic phase. Impurities are back-extracted or stripped from the organic phase into the aqueous phase using water, a freshly prepared scrub solution, or a bleed of the recycled strip liquor. An organic diluent with low density, low viscosity, chemical stability, and compatibility with Cyanex® 272 is used to dissolve the extractant aid. The diluents include but are not limited to kerosene, aliphatic hydrocarbons like naphtha, derivatives thereof, combinations thereof or the like, which are desirable due to their low vapor pressure, resistance to oxidation, high flash point, and complete miscibility with Cyanex® 272. A modifier, such as tributyl phosphate or 1-decanol, can be added to the diluent to improve separation between phases, increase the capacity of the extractant to carry impurities, stabilize the organic phase to prevent third-phase formation, and reduce viscosity. In some cases, sulfonated kerosene is used as a diluent due to its beneficial properties in this process. The purified nickel can be precipitated from the aqueous phase by forming Ni(OH)₂, NiCO₃, Ni₄(CO₃)₃(OH)₂·4H₂O, NiCO₃·Ni(OH)₂·H₂O or similar precipitates. The remaining metals such as lithium can be recovered to Li₂CO₃ or as desired. The purified Li₂CO₃, Ni(OH)₂, NiCO₃ or similar precipitates can be formed with sufficient purity to be reintroduced into the cathode synthesis supply chain with a form that is readily adapted for use to make new cathode active compositions.

Another Cyanex® 272 (based nickel recovery process is described in an article by Feng et al., “Extraction and separation of cobalt and manganese from the leaching solution of cathode materials of waste lithium batteries,” Chinese Journal of Environmental Engineering, Vol. 17, Issue 10, 3367-3373 (2023) (original in Chinese), incorporated herein by reference (hereinafter Feng article). The Feng article is directed to an exploration of the extraction process under controlled conditions and does not perform any testing with actual recovered battery material. In this context, they do not worry about initial purification steps or interference from the host of metals that can be expected in actual systems. In the process of the Feng article, they perform a first extraction step with another extraction aid to purify manganese from other metals. The goal then of the Cyanex® 272 extraction is to obtain purified cobalt. The processing described herein avoids the first extraction step. The focus of the present processing is directed to recovery of purified nickel, and other processing aspects may provide further advantageous recovered materials in addition to the recovered nickel.

As described further below. Cyanex® 272 (di-(2,4,4-trimethylpentyl) phosphinic acid, “C272”) has a strong preference for dissolving in a non-polar organic solvent and is generally, partially neutralized to a salt form for use in an extraction. C272 is used to refer generally to the generic compound, which is commercially available from various suppliers other than the registered trademark owner of Cyanex, Cyensqo. Traditionally, sodium hydroxide has been used to neutralize a selected portion of the extraction aid, although other alkali metal bases or other alkaline compounds could work similarly. To some degree, the neutralization of the C272 is a way to adjust the pH to render the C272 more effective for drawing metal ions into the organic phase with the rejection of the sodium ions. As a result of the neutralization, sodium ions are brought into the organic phase with the C272 in process referred to in the art as saponification. As noted above, the partially saponified C272 has been used for separating cobalt from nickel at certain pH. The extraction is based on the cobalt being more favorable than sodium for bonding with C272 in the organic phase in that pH range, so sodium ions are exchanged for cobalt ions in the organic phase while nickel remains in the aqueous phase. The aqueous phase can be a metal sulfate solution.

Recycling processes in China using C272 have adapted a procedure where nickel sulfate is dissolved into an aqueous solution that is contacted with Na-saponified C272 in organic solvent. In this process, the C272 is first saponified with sodium hydroxide, and then the organic phase is contacted with a solution of nickel sulfate such that nickel replaces sodium in the organic phase. This process has been used to separate nickel from magnesium in an aqueous solution. So the quantity of nickel used to saponify the C272 exchanges with Na⁺ from the initially Na-saponified C272 in the organic phase, which is then separated from the preprepared nickel sulfate aqueous phase after completion of the nickel saponification step. Then, the Ni-saponified organic phase is contacted with a to-be-extracted aqueous phase with a blend of Ni and Mg ions in a sulfate solution. The magnesium exchanges with the nickel ions in the organic phase such that the extracted aqueous phase has both the nickel from the initial aqueous solution to be extracted and the nickel from the organic phase exchanged to the aqueous phase when the magnesium is drawn into the organic phase. Applicant has discovered that nickel saponification can be effective in improving the purification and separation of cobalt and manganese from nickel using C272.

In some embodiments described herein, nickel saponification is found to effectively contribute to the extraction and separation of cobalt and manganese from nickel in a leachate. The nickel saponification can be used to substantially remove the sodium from the organic phase prior to extraction of the sample with nickel, cobalt, manganese and lithium. Effective separation of the cobalt and manganese from the aqueous phase while leaving most of the nickel from the aqueous phase in the aqueous phase and also transferring the nickel from the saponified organic phase back into the aqueous phase.

Referring to the processing approach described herein, the basic workflow begins with the removal of the electrochemical cell's interior from its casing, followed by mechanical shredding to comminute the cell components. The comminuted and cleaned materials, after the removal of large pieces such as iron castings, aluminum foil, copper foil, plastic packaging, and separators, are referred to as ‘black mass’, with a particle size varying from a few micrometers to a few millimeters, a common term in the industry. Further processing typically involves dissolving the black mass to facilitate hydrometallurgical treatment. The dissolving process is generally referred to as leaching and can comprise use of a strong acid, generally sulfuric acid (H₂SO₄), with or without the addition of reducing agents such as H₂O₂, N₂H₄, H₃PO₂ Na₂S₂O₅, Na₂S₂O₃, HCOOH, ascorbic acid, SO₂ or similar to convert the initial metal oxides into soluble metal sulfates. The leachate, i.e., dissolved mixed metal solution, can be filtered to remove remaining undissolvable particulates. This step is fairly general for any recovery process. The dissolved black mass or leachate can then be carried forward into the recovery process. As described below, the overall process after obtaining the black mass from a reductive baking step involves an optional initial removal of the bulk of lithium from the leachate formed using carbon dioxide treatment of the sulfate solution formed with dilute concentrated sulfuric acid used to solvate the lithium in the black mass. The optional removal of lithium at this stage, which is described in more detail below, is convenient but not necessary for the performance of later steps. Separating can comprise a separating step to obtain the purified nickel followed by optional recovery, such as by electrowinning, to obtain pure manganese and/or cobalt, as well as optionally a blend of purified manganese and cobalt. As noted below, separating step comprises the use of extraction aid C272 that assists with drawing Mn⁺² and Co⁺² ions into an organic phase while maintaining Ni⁺² and Li⁺ in an aqueous phase. Improvements in the organic-aqueous extraction provide for efficient and effective purification of nickel and/or lithium that provides for forming battery grade product. In some cases, the nickel source for recovery of nickel from a mixture with manganese and/or cobalt can be intermediate products like mixed hydroxide precipitates (MHP), either purchased or self-prepared, which may be precipitated during the hydrometallurgical processing of minerals, such as laterite ores, or during the recycling of batteries using alternative preliminary processing relative to the teachings herein. Other nickel-rich ore concentrates can also serve as the nickel source for nickel recovery.

To perform the optional initial removal of lithium, the black mass can be optionally leached in two stages. In the initial leaching, the primary target metals, nickel, manganese and cobalt as well as many other metals, remain in the solid mass, and lithium and some additional metals are leached in this first step. The lithium can then be recovered in pure form as described below. A portion of the lithium in the black mass may be in the form of a lithium metal oxide, which would not be stripped of the lithium during the initial leach step. The second leach step converts the metal oxides into metal sulfates, which frees the additional lithium for recovery. This additional lithium is copurified with the nickel, but the nickel can be recovered from this solution to leave the lithium for ultimate recovery or recovered together, if desired.

The next step in the recovery process is conditioning, which involves adjusting the pH of the solution. This process simultaneously removes significant impurities, such as aluminum, copper, and iron, in the form of hydroxides.

Following optional removal of lithium, conditioning or impurity removal is designed in part for achieving an appropriate pH for the subsequent nickel separation. This controlled pH adjustment step with the addition of peroxide also leads to the removal of impurities. Copper ions can be removed through the addition of a suitable reducing agent, such as iron powder. A specific separation step is used to isolate the nickel from manganese and cobalt. The nickel can be a major component of the recovery solution. Specifically, a selected extraction aid is used to effectively isolate the nickel from the other cathode metals and trace amounts of other impurities. The cobalt and manganese are extracted into an organic phase while the nickel remains in the aqueous phase. The nickel can then be precipitated in pure form as nickel(II) hydroxide Ni(OH)₂, NiCO₃, Ni₄(CO₃)₃(OH)₂·4H₂O, NiCO₃·Ni(OH)₂·H₂O or similar precipitates which are only slightly soluble in water. In certain embodiments, lithium can be recovered as battery grade Li₂CO₃ following recovery of nickel or recovered together, and cobalt and manganese can be recovered, if desired, after being stripped from the extractant aids and transferred back to aqueous solution.

The recovery process described herein has some similarities to the process described in U.S. patent application 2024/0145805 to Biederman et al. (hereinafter the '805 application), entitled “A Method for Target metal Removal Via Sulphide Precipitation,” incorporated herein by reference. Lithium-ion cells generally use a copper metal current collector for the anode. The leaching process dissolves the copper along with the other cathode components. The '805 application is directed primarily to the recovery of the copper. In the processing described herein, the copper is recovered by reducing the dissolved copper using iron powder. Iron is inexpensive and significantly does not interfere with the remaining recovery process. The copper then is formed as particulates of copper that can be filtered. In the process of the '805 patent, sodium sulfide (Na₂S) is used to precipitate the copper sulfide CuS, although other metal sulfides can also be precipitated. Such an approach does not result in the formation of copper metal and complicates the recovery of the remaining metals.

The '805 application describes an extraction using organic and aqueous phases along with the use of Cyanex® 272 extractant aid. As described in the '805 application, the extraction process would be very ineffective to significantly purify nickel. Applicant's experiments reported herein essentially confirm the ineffectiveness of such an extraction. The extraction described herein adjusts the pH and significantly increases the organic volumes relative to the aqueous volumes. As described in the examples, these changes surprisingly provide for the purification of the battery scale purity of the nickel.

The cathode of the lithium-ion cells generally use an aluminum current collector. The aluminum in the metal solution can be precipitated along with the iron in the process of conditioning by adding a base along with or without hydrogen peroxide or the like. Aluminum and iron hydroxides are essentially insoluble in water. Standard hydroxide bases, such as sodium hydroxide can be used. However, it can be desirable to use a weaker base to induce the precipitation such as LiO, NH₄OH, NaHCO₃, or Na₂CO₃. The advantage of using a weaker base is that it allows for more controlled pH adjustment to a neutral or slightly acidic level for subsequent steps, preventing localized high concentrations from causing nickel to precipitate out of the solution along with impurities. The precipitation of the iron hydroxide and aluminum hydroxide can be performed under conditions to maintain the other metals essentially dissolved in the liquid. In some cases, H₂O₂, Na₂S₂O₈, CH₃COOOH, Na₂CO₃·1.5H₂O₂ or similar is used to oxidize Fe⁺² to Fe⁺³, allowing it to precipitate out. Following removal of the particulates, copper, iron and aluminum, the active metals from the cathode can be recovered efficiently.

A selective extraction process can effectively and efficiently isolate other metals from the nickel in the metal solution, except for lithium. The extraction process is based on an aqueous/organic separation using a selected extraction aid with selective metal association. Desirable results have been obtained with extraction aid C272, di (2,4,4-trimethylpentyl) phosphinic acid its sodium (Na) or transition metal saponified forms, with an appropriate saponification rate. In particular, a 50-60% saponified C272 is exemplified. C272 has been used for metal purification in a mining context, see Bolden Minerals AB publication “Separation of Cobalt and Nickel using CYANEX 272 for Solvent Extraction,” published Feb. 2, 2021 (Apr. 7, 2021), incorporated herein by reference. The examples provided herein demonstrate the effective separation of nickel from manganese, cobalt and other trace metals resulting from battery recycling. The nickel is recovered in the liquid phase and can be precipitated as nickel hydroxide, while the lithium remains soluble and can be separately recycled or removed in the early stage of the recycling process. Additional details relating to the range of inventive processing and achievement of purified battery grade nickel is described in the Examples. The processing described herein involves a refined process flow to effectively control the metal load of the purification solution at various stages of the purification process. In the context of improved process flow generally, individual process steps can be designed to exploit control of the metal load to obtain effective separation steps that allow for the harvesting of sufficiently purified metals to allow redirection of the purified metals back into the supply chain for electrode formation.

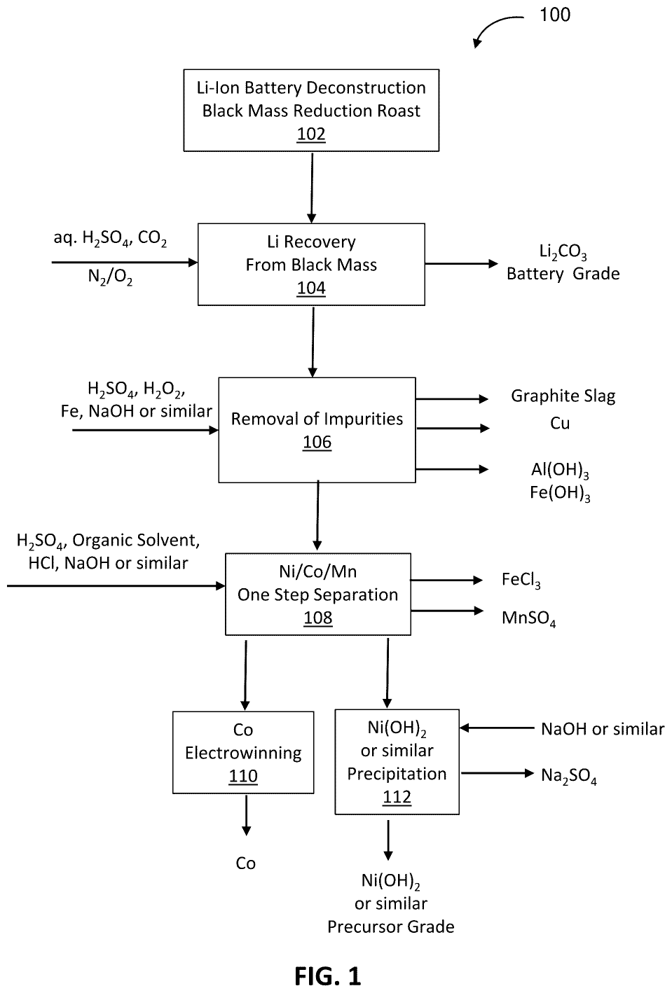

Referring to FIG. 1, overall process 100 can be divided conceptually into 5 steps: 1) lithium ion battery deconstruction leading to black mass recovery followed by a reduction roast of the black mass 102; 2) optional initial lithium recovery 104; 3) removal of impurities 106; 4) separation of nickel, cobalt and manganese ions by extraction 108; and 5) precipitation of nickel hydroxide 112. Cobalt electrowinning 110 can also be carried out to recover cobalt. The division is somewhat arbitrary in terms of the number of steps since steps can be conceptually divided or combined for organizations convenience. Also, some steps may be optional, such as the recovery of lithium can alternatively be performed in the context of a final recovery. Referring to FIG. 1, various inputs and outputs are noted in the general context of the process flow, but variations and alternative adjustments in the process flow are indicated in the more detailed discussion that follows.

The harvesting of the materials from the spent lithium ion cell involves separation of various components that can be physically separated. While portions of the current collectors can be physically separated from the electrodes, contaminating metals from the current collectors are carried forward with the electrode material and can be separated in the ensuing processing. In the first step of the processing, the black mass from the lithium ion cells is optionally roasted to drive the metals into their +2 oxidation states, generally in the form of metal oxides. In some cases, trace amounts of metals are found in their elemental form. The active cathode metals, in particular, nickel, cobalt and manganese, have multiple oxidation states that are accessed during use of the cell. The roasting step provides a more uniform material for continuation into the rest of the process, although the inherent complexities of the combined materials remain. In general, lithium can be present in metallic form and ionized form with an appropriate counter ion, as a mixed metal oxide from a cathode active material. These lithium components may be recovered separately or in some combined fashion.

More specifically, the reduction roast can remove organic components, such as polymer binder, as well as setting the oxidation states of the metals into a low oxidation state, which is +2 for nickel, cobalt and manganese, when the oxidation states are available. The black mass feedstock generally comprises polymer binder and some organic electrolyte remnants along with the metal compositions. The reduction process is generally performed under a nitrogen atmosphere with a low concentration of oxygen. A bulk of graphitic carbon can remain in the low oxygen heating step, but the organics generally are oxidized or decomposed into graphitic carbon. Under the roasting conditions, the carbon present can contribute to the reduction of the metal to the lowest valence state. The roasting of the metal oxides can result in a lower oxidation state through various possible reactions, such as:

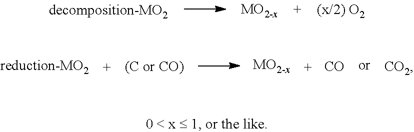

The roasting can be performed at a temperature from about 500° C. to about 950° C. for a time from about 5 minutes to about 5 hours. The atmosphere should be low in oxygen. While a vacuum can be used, this would involve significant capital and pumping requirements. A more cost effective approach would be to use nitrogen or other inert gas, such as argon, although nitrogen can be significantly more cost effective. The input gas can involve a low amount of oxygen, such as a partial pressure of less than about 10 torr, and in some embodiments less than about 1 torr. Molecular oxygen is generally released by reducing metal oxides, although this may be consumed at least in part in the form of carbon dioxide with various carbon sources present. In any case the oxygen content can vary from the input concentration due to the reactions during roasting. A person of ordinary skill in the art will recognize that additional ranges of temperature, time and oxygen content are contemplated and are within the present disclosure.

The roasting process can be performed in a controlled atmosphere oven or the like. While the processing can be performed in a batch process, a continuous heat process can be desirable for commercial scale production. Commercial conveyor based ovens can be used. It is generally desirable to vent the oven through an appropriate scrubber to remove any toxic compounds from the vent gas. For example, a scrubber can be used flowing the vent gas through an alkaline solution, such as NaOH or Ca(OH)₂, to remove toxic compounds. The output from the oven is a roasted black mass comprising metal oxides, metals, such as Al, Cu and Fe, and carbonaceous material.

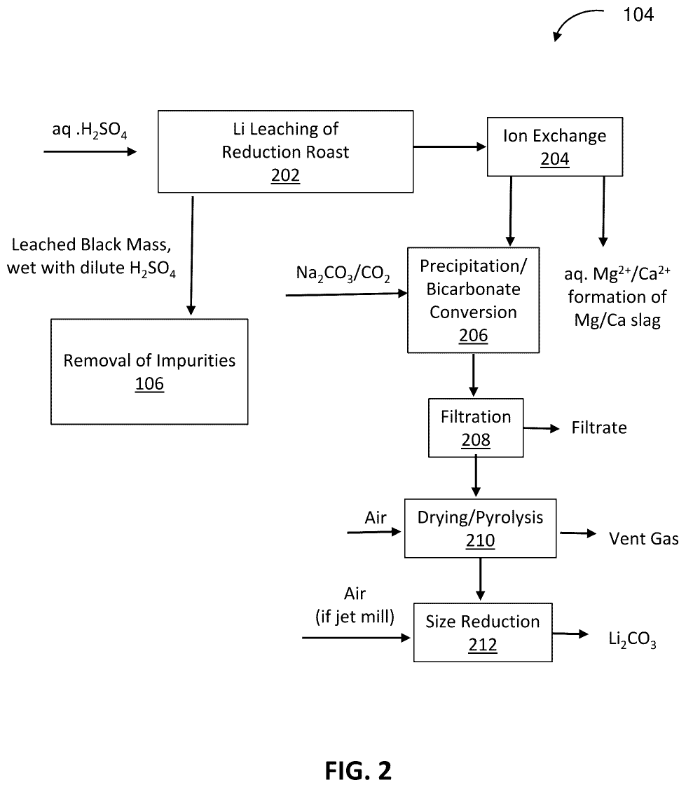

Lithium recovery process 104 is shown in FIG. 2. The process begins with leaching of lithium ions 202 from the reduction roast. Lithium ions in the black mass would generally be converted into lithium oxide during the reduction roast. Lithium oxide (Li₂O) differs from most metal oxides in that lithium oxide slowly dissolves in water to form lithium hydroxide LiOH, which is moderately soluble in water. The solubility can be enhanced using a sulfuric acid solution since lithium sulfite is more soluble and thus drives the solubility. The other metals can also be solubilized in sulfuric acid solutions, so the volume and concentration of sulfuric acid can be kept low to selectively leach the lithium oxide from the black mass. The sulfuric acid solution can have a molarity from about 0.1 M to about 0.5 M. The volume of sulfuric acid can range from approximately 1% to 120% over the amount needed to reach the equilibrium concentration of Li₂SO₄. The leaching solution is at a pH from about 6 to about 7.5 at ambient temperature. A person of ordinary skill in the art will recognize that additional ranges of concentrations and volumes within the explicit ranges above are contemplated and are within the present disclosure.

The leached black mass, wet with dilute sulfuric acid, is carried forward to the next step for continued purification. The solution with lithium can contain some contaminants from divalent alkali earth elements, in particular calcium (Ca⁺²) and magnesium (Mg⁺²). The calcium and magnesium contaminants can be removed using ion exchange 204 in which an ion exchange column can be used to selectively separate the divalent ions of calcium and magnesium from the single valent lithium ions. The output from the ion exchange column with lithium ions can be treated to remove purified lithium compounds. In particular, the lithium can be precipitated as lithium carbonate, Li₂CO₃, in precipitation/bicarbonate conversion 206. A carbonate solution, such as sodium carbonate, as well as CO₂, is bubbled through the solution to form lithium bicarbonate, LiHCO₃, which is then subjected to filtration 208. The filtrate can be disposed of or an adsorbent can be used to adsorb calcium and magnesium ions which can be processed to produce slags. The isolated LiHCO₃ can be subjected to drying/pyrolysis 210 at temperatures from about 100° C. to about 150° C., to convert LiHCO₃ to Li₂CO₃. The product can then be optionally subjected to size reduction 212 using batch or continuous milling processes such as with a jet mill, hammer mill, or media mill.

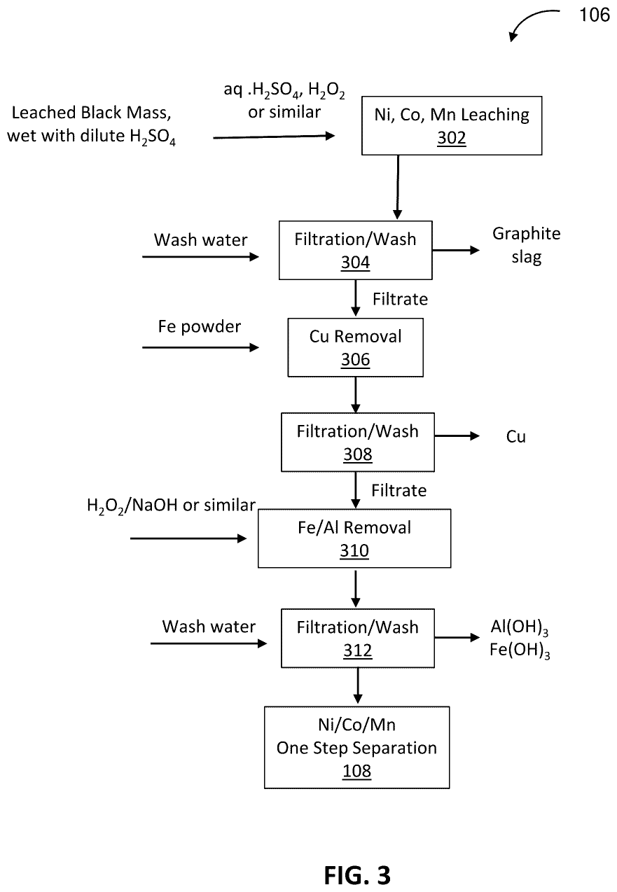

Removal of impurities 106 is shown in FIG. 3. The recovered solids after leaching of the lithium are dissolved to continue the purification process. Ni, Co, and Mn leaching 302 involves treating the leached black mass with sulfuric acid along with hydrogen peroxide. Alternatively, concentrated sulfuric acid can be added directly to the prepared water-mixed black mass slurry. While some metal oxides can dissolve in sulfuric acid, lithium metal oxides (LiMO₂, where M can be Co, Ni, Mn, other metals or combinations thereof, with particular interest in mixtures of Ni, Co and Mn) in the black mass should be reduced while dissolved in the sulfuric acid to simultaneously form lithium sulfate with the other metal sulfates. The volume and concentration of sulfuric acid provide for dissolving these metal oxides that remained substantially in solution while lithium was being leached out. H₂O₂, N₂H₄, H₃PO₂, Na₂S₂O₅, Na₂S₂O₃, HCOOH, H₂O₂, ascorbic acid, SO₂ or similar can be used to facilitate the dissolving process by acting as a reducing agent relative to higher valence metals. The striping of lithium ions from the lithium metal oxide results in a +3 charge for the remaining metal, which is reduced to +2 by the reducing agent. Thus, the presence of H₂O₂, N₂H₄, H₃PO₂, Na₂S₂O₅, Na₂S₂O₃, HCOOH, H₂O₂, ascorbic acid, SO₂ or similar can be used to reduce the metals while dissolving the lithium metal oxides. Alternative reducing agents for the relevant transition metals include iron powder, aluminum powder and copper powder, see Chernyaev, et al., entitled “The interference of copper, iron and aluminum with hydrogen peroxide and its effects on reductive leaching of LiNi_{1/3}Mn_{1/3}Co_{1/3}O₂,” Separation and Purification Technology 281 (2022) 119903, incorporated herein by reference.

The metal sulfates are generally moderately soluble in water. The rates of dissolution for the metal sulfates depends on the concentrations. The sulfuric acid concentration can be from about 0.5M to about 5 M or concentrated sulfuric acid can be used directly if a water-mixed black mass slurry is prepared. The amount of sulfuric acid added is calculated to ensure complete conversion of all metals to their sulfate forms, with a molar excess of 1-50% to account for any process inefficiencies. The volume is generally selected to result in a relatively concentrated metal sulfate composition, although with the metals appropriately solubilized so that target metals are not left in the filter cake. In the metal sulfate solution, the total metal concentration ranges from approximately 80 g/L to 130 g/L, in some embodiments of particular interest, with the nickel concentration specifically ranging from about 40 g/L to 115 g/L. Hydrogen peroxide can be used at a concentration from about 0.025M to about 2M. The leaching of the transition metals can be performed for a time from about 0.5 hour to about 20 hours and at a temperature from about 50° C. to about 99.9° C. A person of ordinary skill in the art will recognize that additional ranges of acid concentration, volume, leach time and temperature within the explicit ranges above are contemplated and are within the present disclosure.

The transition metal leaching can be performed in a batch or continuous reactor. Filtration/wash 304 can be carried out as a fixed bed or slurry, using a batch and/or continuous mode operation, or centrifuging depending on the characteristics of the solids which may require repeated washing. The filter cake following metal leaching generally comprises primarily carbon referred to as a graphite slag. The filter cake can be washed, and the filtrate carried forward for metal purification. The filtrate comprises NiSO₄, MnSO₄, CoSO₄, Li₂SO₄, and sulfates of metal contaminants, such as iron, aluminum and copper. The next step then is to remove the metal impurities to allow for harvesting of purified nickel and possibly cobalt and manganese.

Copper impurities remaining after current collector separation during cell deconstruction may be in elemental form, especially after the reducing roast. Copper present during the leaching can act as a reducing agent, although copper is also susceptible to oxidation by peroxide. Consumption of peroxide to oxidize copper removes peroxide from availability to reduce Ni, Co, Mn and the like from +3 to +2 oxidation states. Nevertheless, to separate the copper from the graphite slag, it can be desirable to oxidize any copper to form solubilized copper sulfate, which can then be recovered. In contrast, the '805 application teaches and claims removal of copper as copper sulfide. Precipitation of copper sulfides is problematic, and the '805 application did not exemplify this precipitation. While the '805 application has three “Examples,” these are prophetic and not actual examples. See Hong et al., “An investigation into the precipitation of copper sulfide from acidic sulfate solutions,” Hydrometallurgy, 192, 105288 (March 2020), incorporated herein by reference.

Once the filtrate is separated from the washed filter cake comprising mainly graphite slag, copper can be separated from the sulfate solution. Iron powder can be added to the metal sulfate solution in Cu removal 306 to reduce the copper while the iron is oxidized. The copper metal can be removed by filtration/wash 308 or other appropriate separation approach. The harvested copper metal can be reused. Removal of the copper reduces any interference from copper during subsequent purification steps. Removal of copper from solution using iron powder should not face the difficulties associated with sulfide precipitation.

Next, iron and aluminum ions can be removed from the filtrate in Fe/Al removal 310 by adjusting the pH with sodium hydroxide and/or other alkaline compounds. The pH can be adjusted to a value from about 3.5 to about 6.5 pH units to induce precipitation. The quantity of alkaline addition can be correlated with the desired pH change. Filtration/wash 312 is used to remove Fe(OH)₃ and Al(OH)₃ as solids. Fe(OH)₃ [(FeO(OH)·H₂O] and Al(OH)₃ are insoluble in water (FeO(OH)) or significantly less soluble (Al(OH)₃) than the remaining metal hydroxides (Ni, Co, Mn). Thus, after neutralization of the mixed metal sulfate, iron +3 (Fe⁺³) and aluminum +3 (Al⁺³) are precipitated and filtered from the solution. As noted above, H₂O₂, Na₂S₂O₈, CH₃COOH, Na₂CO₃·1.5H₂O₂ or similar can be used to ensure that the iron and aluminum are in the +3 oxidation state. A person of ordinary skill in the art will recognize that additional ranges within the explicit ranges above are contemplated and are within the present disclosure.

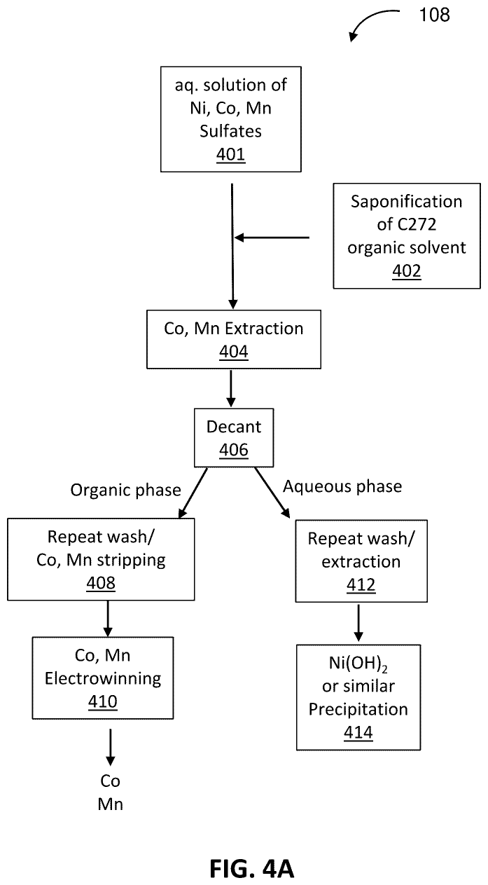

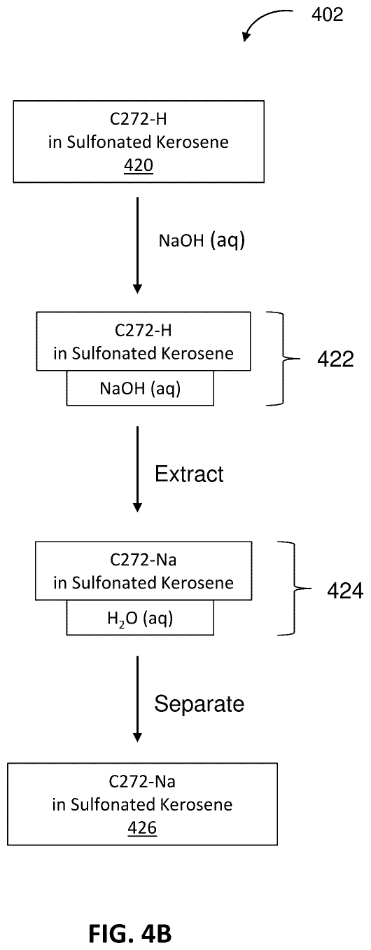

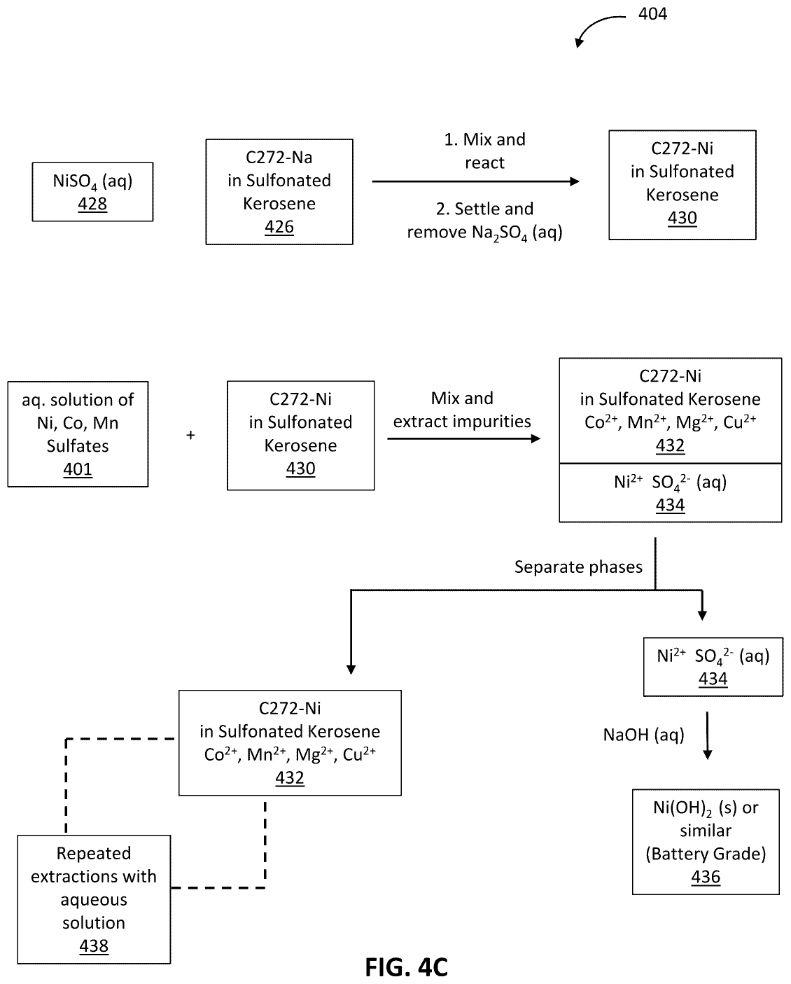

Next step Ni/Co/Mn one step separation 108 is depicted generally in FIG. 4A and in more detail in FIGS. 4B-4D. As used herein, Ni/Co/Mn one step separation refers to the use of a single extraction aid to accomplish separation of Ni from Co and Mn. Brief descriptions of FIGS. 4A-4D are provided to facilitate discussion of the extraction process which follows.

After removal of the majority of the aluminum and iron, the metal sulfate solution is ready for an organic extraction to separate the nickel from the cobalt and manganese. Extraction aid, Cyanex 272 is used to assist with this extraction. Cyanex 272 (hereinafter C272) is described above. In the examples, this extraction is performed without the benefit of the prior complete impurity removal described for copper, aluminum, iron and other contaminant metals. Nevertheless, the exemplified process is successful to purify nickel to a desired degree. Along with proper preparation of the metal sulfate solution, the conditions of the organic-aqueous extraction should be designed to achieve a desired strong separation of the metal species. In particular, the nickel and optionally lithium ions should be substantially in the aqueous phase and the cobalt and manganese ions should be substantially in the organic phase. Two parameters of particular interest for the extraction are the pH and the organic to aqueous volumes.

A general scheme of the liquid-liquid extraction process is shown in FIG. 4A. Aqueous solution of Ni, Co and Mn sulfates 401 is obtained after removal of Fe(OH)₃ and Al(OH)₃ as solids. Aqueous solution 401 is combined with saponified C272 in organic solvent 402, prepared as described below and in FIG. 4B, and the phases are allowed to phase separate as Co and Mn are extracted into the organic phase 404. The aqueous and organic phases are physically separated by decanting 406 the organic phase from the aqueous phase. The organic phase is subjected to repeated aqueous washes 408 to obtain Co and Mn in an organic phase suitable for electroextraction of the elements as metals 410. The aqueous phase is subjected to repeated extractions 412 using an organic phase to obtain an aqueous solution of Ni ions which is then treated to precipitate Ni(OH) or similar precipitates 414.

Saponification of C272 402 is shown in FIG. 4B. Sulfonated kerosene, mineral oil or the like is added to the extraction aid to form organic solution of C272-H 420. The organic solution of the extraction aid is combined with aqueous NaOH as shown by phases 422. The phases are mixed and allowed to separate as shown by phases 424 and represented as an exchange of H⁺ and Na²⁺ to form saponified extraction aid C272-Na from extraction aid C272-H. Isolation of the organic phase provides C272-Na in sulfonated kerosene/mineral oil 426.

In exemplified embodiments, conversion of saponified extraction aid C272-Na to the corresponding Ni salt 403 is shown in FIG. 4C. Aqueous solution of NiSO₄ 428 is prepared, then combined with C272-Na in sulfonated kerosene 426. The two solutions are mixed, then allowed to phase separate to form organic phase comprising C272-Ni in sulfonated kerosene 430. Conversion to C272-Ni is represented as an exchange of Na⁺ and Ni²⁺.

Separation of Ni from Co and Mn 404 is shown in FIG. 4D. C272-Ni in sulfonated kerosene 430 is combined with aqueous solution of Ni, Co and Mn sulfates 401 obtained as described above for FIG. 3. The two solutions are mixed, then allowed to phase separate to form organic phase 432 and aqueous phase 434. Organic phase 432 comprises a reduced amount of C272-Ni relative to that present in organic phase 430, C272-Co, and C272-Mn. Organic phase 432 can comprise other complexes of C272, such as C272-Mg and C272-Cu, if the cations are present as impurities in Ni/Co/Mn sulfate solution 401. Aqueous phase 434 comprises Ni²⁺ and SO₄²⁻, along with any lithium ions that were originally present. The phases are separated and aqueous phase 434 is subjected to repeated extractions 438 with organic solvent. Aqueous phase 434 is treated with aqueous NaOH, Na₂CO₃, NH₃HCO₃, (NH₃)₂CO₃, or the like to precipitate 436 Ni(OH)₂, NiCO₃, Ni₄(CO₃)₃(OH)₂·4H₂O, NiCO₃·Ni(OH)₂·H₂O or similar solids out.

Extraction aid, Cyanex 272 is used to assist with this extraction. Cyanex 272 (hereinafter C272) is described above. In the examples, this extraction is performed without the benefit of the impurity removal described for copper, aluminum, iron and other contaminant metals. Nevertheless, the exemplified process is successful to purify nickel to a desired degree. Along with proper preparation of the metal sulfate solution, the conditions of the organic-aqueous extraction should be designed to achieve a desired strong separation of the metal species. In particular, the nickel ions should be substantially in the aqueous phase and the cobalt and manganese ions should be substantially in the organic phase. Two parameters of particular interest for the extraction are the pH and the organic to aqueous volumes.

The general principles of liquid-liquid extraction or separation are understood, although there are many nuances for consideration. The basic principle is that components to be separated should be selectively having a greater solubility in one phase relative to the other compositions, which can be described in terms of partition fractions. To achieve higher efficiency, it is desirable to enhance the differences in solubilities between the species to be separated from each other. To this end, the C272 significantly enhances the solubilities of Mn⁺² and Co⁺² in the organic phase. The C272 is added to the organic phase, such as at a concentration from about 2 volume percent (vol %) to about 25 vol % and in further embodiments from about 5 vol % to about 20 vol %. The amount of C272 can be selected to be roughly equal or slightly greater on an equivalent (molar multiplied by charge magnitude) basis relative to the metals to be sequestered into the organic phase. A person of ordinary skill in the art will recognize that additional ranges of C272 concentrations within the explicit ranges above are contemplated and are within the present disclosure.

Suitable organic liquids should be immiscible in water, and good phase separation in a desirable time frame suggests clear non-polar properties of the organic phase. Since gravity drives the phase separation, it can be desirable for the organic phase to have a lower density than water with a greater density differential supportive of more efficient phase separation. Also, the pH has been found to be a significant factor influencing the relative solubilities into the organic and aqueous phases, as described further below.

The organic solvent should be selected to be immiscible with water so that a good phase separation can be obtained. Thus, the organic solvent is generally non-polar. Suitable solvents include, for example, kerosene, sulfonated kerosene, mineral oil, naphtha, more refined versions thereof and the like. These organic solvents generally comprise a blend of alkanes and potentially other hydrocarbons and derivatives thereof. Suitable organic solvents can be complex mixtures obtained from crude oil refining or other fossil fuel production, industrial grade solvents can be significant from a cost standpoint. The density of the organic solvent generally is no more than about 0.925 g/ml.

As noted above, Cyanex 272 (C272) is a dialkyl phosphinic acid. It is a weak acid, and efficacy as an extractant can be enhanced by a partial degree of deprotonization. It is generally used in an organic phase at a concentration from about 2 to 25 percent by volume or any subrange of concentrations within this explicit range. In the art, the deprotonization is generally referred to as saponification, although alternatively it could be referred to as neutralization of the acid. Since there are two phases involved, perhaps no analogy to one phase systems quite works as an equivalent. The two phase equilibrium can be represented as:

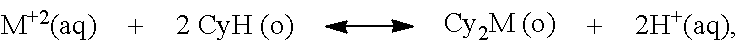

where M is the divalent metal, “Cy” is Cyanex 272, (o) indicates the organic phase, and (aq) represents the aqueous phase. So raising the pH and removing H⁺ from the aqueous phase tends to drive the equilibrium toward the right. But if too effective, the nickel may be undesirably also driven into the organic phase. So extraction conditions may be balanced to improve separation of the desired metal elements. A saponified C272 helps maintain a stable pH during the solvent extraction process, eliminating the need for additional base solutions for stabilization, which is necessary when using pure C272. As more H⁺ ions enter the aqueous solution, it becomes more acidic.

Referring to saponification of C272 402 as shown in FIG. 4B, the saponification generally is performed using sodium hydroxide, but alternative alkali compounds could be used. But sodium hydroxide is inexpensive and sodium cations should not interfere with any purification steps. The “degree” of saponification, as used in the art, can be evaluated based on hydroxide equivalents added relative to the C272. An alternative approach can be based on the pH based on weak acid equilibrium relationships. A pH based approach can be independent of the effects of the initial pH, which is influenced by the amount of sulfuric acid used to dissolve the black mass. The degree of saponification can be from about 15% to about 80%, in further embodiments form about 30% to about 70% and in additional embodiments from about 45% to about 65% saponified. The pH can range from about 3 to about 6.5 pH units. A person of ordinary skill in the art will recognize that additional ranges of degree of saponification and pH within the explicit ranges above are contemplated and are within the present disclosure.

The phase separation can be enhanced through a process supplementing the sodium “saponification,” by further replacing sodium in sodium saponified C272 with alternative cations that can facilitate further processing, such as nickel as shown by process 403 in FIG. 4C or ammonium cations, before mixing the solvent with the leachate for solvent extraction, a process commonly referred to as nickel saponification in the field. Nickel saponification of C272 is achieved by reacting nickel salt, such as nickel sulfate, with sodium-saponified C272. In this reaction, nickel displaces sodium, causing sodium to migrate out of the oil phase and forming a sodium sulfate solution. To reduce cost as well as to reduce the amount of nickel to be recovered, ammonium (NH₄⁺) can be an alternative cation, which can be provided as ammonium hydroxide. Alternatively, ammonium hydroxide can be used in place of sodium hydroxide in the initial saponification process above. The degree of saponification can be from about 15% to about 80% and in further embodiments form about 30% to about 70%. The amount of nickel sulfate added can correspond approximately on an equivalent (molar times charge) basis with the amount of sodium to be displaced from the organic phase. In this way, the sodium can be removed to the aqueous phase where it separates and can be disposed of, while the organic phase becomes the nickel-saponified material for extraction of the sample to separate nickel and coincidently lithium from cobalt and manganese. The nickel-saponified C272 in the oil phase then acts as an organic solvent when mixed with the metal sulfate solutions to be separated, effectively extracting manganese, cobalt and other ions except nickel and lithium. In principle, the nickel in C272 exchanges with manganese, cobalt, and other impurities at an optimal pH range of 3.5 to 6.5, with a preferred range of 4.0 to 5.8, where the pH range refers to an aqueous phase used to contact the organic phase. The nickel ions introduced during nickel saponification reduce the sodium concentration in the resulting nickel sulfate aqueous phase while increasing the nickel content in the final nickel aqueous solution. A person of ordinary skill in the art will recognize that additional ranges of degree of saponification or pH within the explicit ranges above are contemplated and are within the present disclosure.

Referring to Co & Mn extraction 404 as shown in FIG. 4D, the liquid-liquid extraction can be performed based on various commercial equipment that can be adapted for the processing. Processing can be performed in a batch or continuous operation as well as in a single extraction or multiple stages. Multiple stages can be similarly performed using repeated extraction of the aqueous phase to continuously remove more impurity metals or using counter current extraction process. Regardless of the format, the process parameters include, for example, initial aqueous concentrations and composition, organic to aqueous volume ratios, number of extraction steps, organic solvent composition, extraction aid concentration, extraction temperature, and equilibration time. With respect to the volume ratios and the extraction steps, these are interrelated issues since a quantity of organic solvent can be used for a single extraction step or divided into multiple individual separation steps. Selection of parameters can be influenced by cost and efficiency issues since the total amounts of solvents generally are desired to be low from multiple perspectives. The Examples demonstrate similar results from a single larger volume extraction compared with three divided extraction steps performed in batch mode.

From a batch perspective, multiple smaller organic volume extractions can allow for smaller process vessels and perhaps shorter phase separation times. As a general objective, to fully separate the target metals, it is desirable to perform each extraction step to move as much of the target metals (Co and Mn) into the organic phase while leaving close to all of the nickel in the aqueous phase, while with nickel saponification also transferring nickel from the organic phase to the aqueous phase. At the end of the extraction process, the aqueous phase can have the purified nickel from the original sample plus nickel recovered from the nickel saponified organic extraction solution. The extraction steps can be organized around this objective.

Repeat wash/Co stripping 408 and repeat wash/extraction 412 refer, respectively, to repeated washing and decanting steps used to strip the organic phase of Co and purify the aqueous phase before precipitation of Ni(OH)₂ or similar precipitated as described above.

Single or multiple stage extractions can be performed with devices referred to as mixer-settlers. The extractant aid is dissolved in the organic phase to prepare for the extraction process. When the two phases are combined, these should be well mixed to allow for the phase partitioning of the metal ions on a reasonable time frame. When the mixing is stopped, the two phases can separate. Settlers can be designed to efficiently continuously separate the originally mixed blend by siphoning from the top and bottom of the flow from the mixer without waiting for a long settling time. Commercial mixer-settlers are readily available. Of course, for development purposes, laboratory scale experiments can be performed manually with a separation funnel or the like that provides one stage of separation in which mixing and phase separation are performed in the same vessel.

In general, for dilute solutions undergoing liquid-liquid exchange, the basic principles are fairly well established, and parameters related to the solvent partitioning can be specified. For concentrated solutions that may be desirable to keep volumes low, the basic principles still apply, although some quantitative changes may result. In general, multiple extraction steps can be balanced against a larger organic to aqueous volume ratio. The use of multiple extraction steps with smaller organic volumes allows for the use of smaller process equipment, but it generally increases the process time or number of extractors (e.g., mixer-settlers) if used in series. Ultimately, the good separation of Ni⁺² from Co⁺², Mn⁺² and other impurities is the criteria to evaluate success of a separation protocol, in which strong secondary factors involve process efficiencies, costs and capital equipment demands.

As demonstrated in the examples, the extraction conditions can effectively result in excellent separation of nickel from cobalt, manganese and impurities using increased organic to aqueous volume ratios and/or using more extraction stages. The total organic volumes may or may not be roughly equivalent from the use of more stages versus the use of large organic volumes in fewer stages, but these considerations can be accounted for accordingly. Generally, the nickel rich aqueous phase is carried forward through the stages if there are multiple stages, and organic phases can be pooled for recovery of cobalt and/or manganese from multiple extraction steps. In some embodiments, the volume ratio (organic volume divided by aqueous volume) for each extraction stage can be from about 0.1 to about 50, in further embodiments from about 0.25 to about 25, in additional embodiments from about 0.5 to about 20, and in some embodiments from about 1 to about 15 as the ratio ranges of organic volumes divided by aqueous volumes. As demonstrated in the Examples, the extractions can be performed in a single effective extraction stage with a large enough extraction volume. In multiple extraction stages, the number of extraction stages can be 2 or more with no limit in principle, but in some embodiments from 2 stages to 20 stages, in further embodiments form 2 stages to 10 stages, and in additional embodiments from 3 stages to 6 stages. Some heating of the solution during extraction may assist with the extraction process, although the extraction can be done at room temperature. In some embodiments, the extraction can be performed at a temperature from about 40° C. to about 95° C. and in further embodiments from about 45° C. to about 80° C. A person of ordinary skill in the art will recognize that additional ranges of solvent ratios, stage numbers and temperature within the explicit ranges above are contemplated and are within the present disclosure.

Large scale commercial solvent extractions are generally performed using multistage countercurrent continuous extraction. A series of extractors sequentially perform the extractions with the aqueous and organic phases from one phase passed on to subsequent stages in an opposite sense. Each stage of the countercurrent extraction can be performed with an appropriate extraction apparatus, such as a mixer-settler or other comparable component.

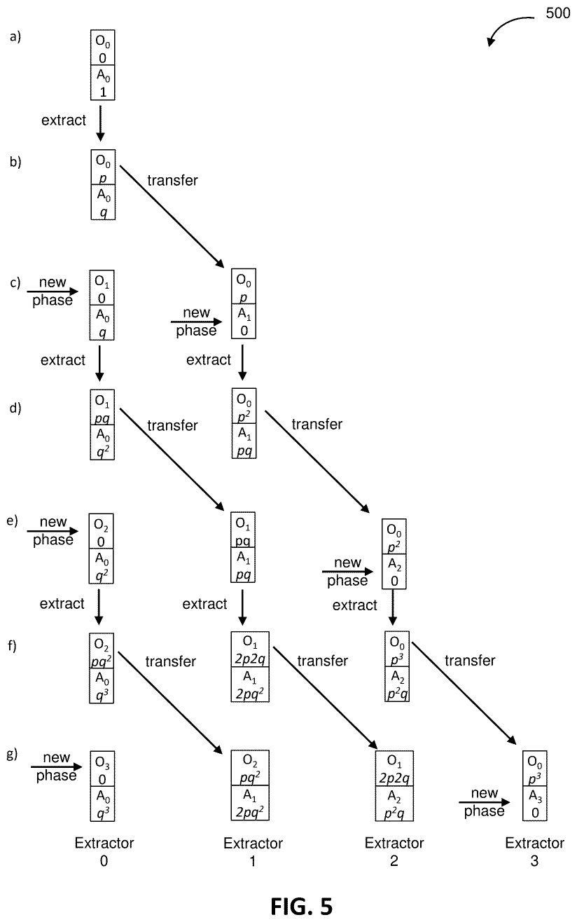

The conceptual framework of a countercurrent extraction is depicted schematically as process 500 as shown in FIG. 5. Extractors 0-3, from left to right, are depicted vertically with seven steps labelled a)-g). Generally, the aqueous phase is extracted with 3 portions of “fresh” new organic phase as the steps increase from a to g. After each extraction, the phases are separated with the organic phases being transferred to the next extractor. The purity of the aqueous phase increases with each extraction. The first organic phase collected in Extractor 1 is extracted with 1 new aqueous phase and extractions are repeated as organic phases are collected. Each time the collection of organic phases is extracted, the phases are separated with the organic phase being transferred to the next extractor, Extractor 2. The aqueous phase collected from Extractor 2 can then be recirculated and reextracted any number of times until a desired level of purity is obtained. Likewise, the organic phases can be continued to be transferred to a separate extractor and extractions with aqueous phase carried out until desired components from the collected organic phases are extracted to an acceptable level remaining in the collected organic phases.

Referring to the nomenclature of process 500, the extraction sequence for Extractor 0 is described. Step a) begins with initial organic phase O₀ 0 and initial aqueous phase A₀ 1. The extraction is carried out, leading to step b) with organic phase O₀ 0 becoming organic phase O₀ p and aqueous phase A₀ 1 becoming aqueous phase A₀ q. The phases are separated and organic phase O₀ p is transferred from Extractor 0 to Extractor 1. Aqueous phase A₀ q is brought forth to step c) and extracted with new organic phase O₁ 0, leading to step d) with new organic phase O₁ 0 becoming organic phase O₁ pq and aqueous phase A₀ q becoming aqueous phase A₀ q². The phases are separated and organic phase O₁ pq is transferred from Extractor 0 to Extractor 1. Aqueous phase A₀ q² is brought forth to step e) and extracted with new organic phase O₂ 0, leading to step f) with new organic phase O₂ 0 becoming organic phase O₂ pq² and aqueous phase A₀ q² becoming aqueous phase A₀ q³. At step e), a third extractor is engaged with organic phase O₀ pq² and a new aqueous phase A₂ 1. The phases in each extractor are mixed and separated, and organic phase O₂ pq² is transferred from Extractor 0 to Extractor 1, and other extractors in use are similarly transferred. Aqueous phase A₀ q³ is brought forth to step g) and extracted with new organic phase O₃ 0, and other extractors are similarly cycled with a new extractor coming into use at the next stage of the extraction.

At each stage, one new unit of water and organic solvent with extractant (C272) is used for extracting one of the ongoing extraction stages where the organic and aqueous solvent volumes increase by one unit each for each stage, where the volume of each solvent unit depends on the aqueous/organic ratio. Conceptually, with a series of physical extractors, this can be considered equivalent to the aqueous phases moving sequentially downward through the extractors and the organic phase moving upward through the array of physical extractions since new extractors of the array are introduced at a subsequent stage, which is consistent with the terminology. Final aqueous and organic volumes may be combined or in total or selectively combined if only a fraction of the samples have the desired level of purity.

Referring again to FIG. 5, four extraction stages are depicted for a countercurrent extraction process. While the conceptual process can be adapted for implementation on available extraction equipment, at each stage of the extraction, in a separation step, the organic phase is removed and transferred to a different extractor. Once a third extractor is added, previously extracted aqueous solutions and previously extracted organic solutions are combined for further extraction, while the conceptual end solutions are extracted with fresh aqueous or organic solvents, with the extraction aids in the organic solvents. After completing the extraction, if applicable, the aqueous phases from each stage can be combined for further purification and isolation of the metals, and correspondingly the organic phases can be similarly combined. Each extraction stage can have a selected ratio of organic volume relative to the aqueous volume.

Following the organic/aqueous extractions, the aqueous phase should be nickel rich with only contaminant metals that can be readily separated from the nickel such that nickel can be recovered in sufficiently pure form. Under the process approach described herein, the primary metal contaminant to the aqueous nickel solution is lithium ions, sodium Na⁺, and/or ammonium NH₄⁺. The nickel can be effectively separated from lithium in solution by precipitation. Specifically, nickel can be precipitated by addition of hydroxide such that nickel hydroxide can be harvested by filtration and washed. The harvested nickel hydroxide can be sufficiently pure to reintroduce the nickel into the supply chain for forming new lithium metal oxide active materials. In general, the nickel hydroxide can be more than 99% by weight pure with respect to metal content, in further embodiments at least about 99.25 wt % pure and in other embodiments at least 99.5 wt %. A person of ordinary skill in the art will recognize that additional ranges of nickel purity within the explicit ranges above are contemplated and are within the present disclosure.

Following precipitation of the nickel, the aqueous solution comprises primarily lithium metal ions. The lithium can be recovered by carbonate precipitation, as described above for initial removal of lithium from the black mass, or by electrowinning, which involves lithium metal harvesting using electroextraction, an electrolytic process essentially involving electroplating of the lithium metal out form solution. Since lithium is highly electronegative, any other metal contaminants in the solution can plate as a contaminant, but the lithium can be highly pure since the solution can be purged well with respect to other metal contaminants following the organic extraction and precipitation of the nickel. Alternatively, if lithium carbonate is a desirable product, the lithium can be recovered by precipitation and combined with the precipitated lithium from the optional lithium recovery step.

With respect to the organic phase, the organic extracted metals can also be recovered. Recovery of these metals involves freeing the metal ions from the extraction aid associated with the metal. Based on the procedures described herein, the organic phase comprises mainly cobalt and manganese metal ions with potentially trace impurities of other metals such as Al, Fe, Cu, Zn, Mg, Ca and others. A step providing for the recovery of the cobalt and manganese metals involves transitioning the metal ions back into an aqueous solution to allow for manipulations available in aqueous solution. This transition back into the aqueous solution essentially can be performed through a reversal of the saponification, and sulfuric acid can be used to reduce the pH. The acidic aqueous solution should be mixed with the organic phase from the extraction step. The lowering of the pH tends to protonate the C272, which results in the destabilization of the metal ions in the organic phase resulting in the reverse extraction, or migration back to the aqueous phase of most of the metal ions. Of course, the aqueous phase initially can be essentially metal free for this step.

With the metals back in the newly formed aqueous phase (not to be confused with the purified nickel rich aqueous phase), the cobalt and manganese can be recovered for reuse. While these can be co-recovered, it can be desirable to separately recover. For co-recovery, the metals can be precipitated together as insoluble salts, such as carbonates or hydroxides (with organic phase and C272 removed). The co-recovery of the cobalt and manganese can be a straightforward process to produce a lower grade material that can be sold for appropriate uses. In some embodiments, if the majority of contaminating metals have been removed prior to liquid-liquid extraction, and since nickel has been extracted away, the co-recovered metals can be a relatively pure blend of cobalt and manganese in proportion to their presence in the black mass accounting for any loss during the purification process. Upon reintroduction into the supply chain, compositional adjustments can be made to match a desired stoichiometry with the addition of pure metal compositions in desired amounts.

In principle, electrowinning can be used to sequentially electro deposit the respective metals with manganese recovered first followed by cobalt. The electrode potentials can be controlled to selectively recover the manganese, which has a lower reduction potential. Once most of the manganese is selectively removed, then cobalt can be electrodeposited.

Based on this carefully staged recovery procedure, various metals can be recovered very efficiently and effectively to recover one or more battery grade materials. In some embodiments, since nickel may be the dominant metal component in the feed material, recovering nickel in a sufficiently purified form for reuse in the battery supply chain can be a major goal. This can be achieved by obtaining pure Ni(OH)₂ or by incorporating other dopants and elements as required for specific product needs and/or with Li₂CO₃ or similar. The ability to optionally also recover other purified metals is a significant bonus for this process flow.

The process parameters described herein are specific to the composition of the black mass utilized. When higher nickel content is present in the black mass and other feed stocks, the pH value, the type and quantity of reducing and oxidizing agents, the organic solvent-to-aqueous ratio during solvent extraction, and the number of extraction stages may vary depending on the feedstock conditions. A person of ordinary skill in the art will recognize how to correspondingly adjust such parameters based on the teachings herein.

### EXAMPLES

### General Procedures

Elemental analyses were carried out with Inductively Coupled Plasma Optical Emission Spectroscopy (ICP-OES) from Thermo Scientific.

Oxidation-reduction potentials (ORPs) were determined by pH/ORP meter (Ag/AgCl reference electrode) from Shanghai Leici Instrument Factory

### Materials

The following materials were used in the examples:

Black Mass (BM)—A mixture of cathode powder scrapes and spent battery waste was obtained as a pre-processed black mass, referred to as BM, with a reported weight ratio for Ni:Mn:Co of 0.632:0.193:0.175.

An extract including organic phosphinic acid compounds was obtained commercially corresponding to Cyanex® 272.

Sulfurized or sulfonated kerosene or mineral oil was obtained as it is.

### Extraction From Black Mass

Two black mass samples (BM-1 and BM-2) were analyzed with inductively coupled plasma to determine weight percentages for Ni, Li, Co, Mn, Cu, Fe, Al, F, P and Ca. Results are shown in Table 1.

TABLE 1

| | BM-1 | BM-2 |
|---|---|---|
| Element | (wt %) | (wt %) |
| Ni | 24.6 | 28.15 |
| Li | 4.63 | 4.41 |
| Co | 7.09 | 6.56 |
| Mn | 9.01 | 7.41 |
| Cu | 0.59 | 0.37 |
| Fe | 1.04 | 0.63 |
| Al | 1.08 | 0.83 |
| P | 0.55 | 0.35 |
| Ca | — | — |
| other | 51.41 | 51.29 |
| total | 100 | 100 |

“—” means “not measured”.

The present experiment presents a particularly challenging test of nickel purification since the black mass was not subjected to extensive initial purification prior to the solvent-liquid extraction, but the process still is able to achieve highly purified nickel. A total of 150 g of black mass was mixed with tap water at a 1:3 weight ratio to form a slurry. Concentrated sulfuric acid (98% H₂SO₄) was then added to the slurry, with the amount pre-calculated to ensure complete conversion of metals to metal sulfates. The final volume of H₂SO₄ was determined based on pH measurements and oxidation-reduction potential (ORP). After leaching for 3-8 hours at 75 to 80° C., maintaining a pH between about 0.8 to about 1.5, the resulting leach solution was separated from the remaining solids, or leach cake. The ORP of the solution was measured and recorded to be between about 380 mV to about 500 mV, indicating that nearly all metals had been extracted into solution as metal ions. Both the leach solution and the leach cake were subsequently analyzed for elemental composition. The leach cake had values of less than 1 wt % for all of the measured metals. In addition to the Ni, Co and Mn elements, the leachate had greater than 1 wt % of lithium, copper and aluminum along with somewhat less of iron. The leaching efficiency achieved was 95.66% to 98.34% for nickel (Ni) and 94.64% to 98.41% for cobalt (Co).

### Removal of Impurities

As an alternative to impurity removal and recovery described above, a simplified impurity removal was performed based on precipitating a majority of the contaminating metals while leaving the metals for primary interest still in solution. The pH of the leach solution was increased to about 4.5 to about 5.5 to cause precipitation of Cu, Fe, Al, and Ca. The pH was increased stepwise. The resulting leach solution (Ni/Co/Mn sulfate solution) and solids were separated and analyzed to determine amounts of the elements. Results are shown in Tables 2A and 2B, for two black mass samples.

TABLE 2A

| | Ni | Li | Co | Mn | Cu | Fe | Al | P |
|---|---|---|---|---|---|---|---|---|
| BM-1, wt % | 24.6 | 4.63 | 7.09 | 9.01 | 0.59 | 1.04 | 1.08 | 0.55 |
| Leachate | 69.4 | 12.88 | 16.8 | 22.58 | 0.41 | 1.86 | 2.9 | 0.97 |
| from | | | | | | | | |
| BM-1, g/L | | | | | | | | |
| Leaching | 98.9 | 99.16 | 98.95 | 98.76 | 55.94 | 97.76 | 97.67 | — |
| efficiency | | | | | | | | |
| from | | | | | | | | |
| BM-1, % | | | | | | | | |
| After pH | 57.96 | 11.37 | 14.93 | 20.1 | 0.018 | 1.18 | 0.029 | 0.046 |
| adjustment | | | | | | | | |
| from | | | | | | | | |
| BM-1, g/L | | | | | | | | |
| Metal | 91.41 | 98.71 | 95.85 | 98.03 | — | 64.77 | 23.14 | — |
| retaining | | | | | | | | |
| after pH | | | | | | | | |
| adjustment | | | | | | | | |
| BM-1, % | | | | | | | | |

TABLE 2B

| | Ni | Li | Co | Mn | Cu | Fe | Al | P |
|---|---|---|---|---|---|---|---|---|
| BM-2, wt % | 28.15 | 4.41 | 6.56 | 7.41 | 0.37 | 0.63 | 0.83 | 0.35 |
| Leachate | 57.29 | 14 | 15.48 | 29.42 | 0.82 | 1.97 | 4.21 | 0.81 |
| from | | | | | | | | |
| BM-2, g/L | | | | | | | | |
| Leaching | 99.85 | 99.89 | 99.8 | 99.89 | 49.21 | 98.56 | 98.61 | — |
| efficiency | | | | | | | | |
| from | | | | | | | | |
| BM-2, % | | | | | | | | |
| After pH | 39.26 | 12.36 | 20.74 | 9.96 | 0.012 | 0.54 | 0.0045 | — |
| adjustment | | | | | | | | |
| from | | | | | | | | |
| BM-2, g/L | | | | | | | | |
| Metal | 91.3 | 106.29 | 93.72 | 94.62 | 1.92 | 36.52 | 0.14 | — |
| retaining | | | | | | | | |
| after pH | | | | | | | | |
| adjustment | | | | | | | | |
| BM-2, % | | | | | | | | |

The leachate from the two black mass samples were combined for further processing.

### Extraction of Ni(JJ)

A 10 wt % solution C272 in sulfurized kerosene or mineral oil was prepared and mixed with a 32 wt % solution of NaOH. Saponification was carried out by mixing of the solutions at 60-65° C. to saponify about 50-60 mol % of di-alkyl phosphinic acid components. The sodium saponified organic phase was mixed with an aqueous nickel sulphate solution having an approximate equivalent (molar times charge) amount of nickel as sodium in the saponified organic phase. The resulting organic phase was carried over to the sample solvent-solvent extraction.

The Ni/Co/Mn sulfate (leachate) solution was extracted with the saponified C272 extract solution at room temperature and at volume ratios for two separate extractions of 1:1 and 3:1 for organic/aqueous (O/A). Results are shown in Table 3. The data suggest the extractions did not provide sufficient separation of the other metals from nickel. The Mn concentration in the aqueous phase decreased only slightly, to about 82% of original, for the 1:1 organic-to-aqueous (O/A) extraction, and to about 57% for the 3:1 O/A extraction. This indicates inefficient separation or extraction. A similar trend was observed for Co, which decreased to about 91% of original in the 1:1 O/A extraction and to about 88% in the 3:1 O/A extraction. This inefficiency in separation was attributed to the high extraction pH of 5.2 to 6.2, as well as an insufficient amount of organic phase.

TABLE 3

| | Before | Aqueous Phase | Aqueous Phase |
|---|---|---|---|
| | Extraction | 1st Extraction 1:1 | 1st Extraction 3:1 |
| Element | (g/L) | (g/L) | (g/L) |
| Ni | 51.16 | 51.90 | 58.44 |
| Li | 9.56 | 9.22 | 9.43 |
| Co | 13.45 | 12.21 | 11.80 |
| Mn | 13.7 | 11.12 | 7.87 |

Another extraction was performed at a volume ratio of from about 8:1 to about 12:1 organic-to-aqueous (O/A). In this case, the aqueous solution was filtered through a carbon filter to remove any residue oil in the aqueous solution before testing. The results, presented in Table 4, indicate that the majority of Co, Mn, and other ions were effectively extracted from the aqueous phase, leaving only trace amounts of Co and Mn. This suggests that the 10:1 O/A extraction provides sufficient separation of these metals from nickel, allowing for the precipitation of nickel hydroxide or similar forms with dopants or other incorporated elements depending on the product requirements, and the potential to achieve battery-grade product. Notably, the data demonstrate that under optimized conditions, Co and Mn can be effectively separated from Ni, representing a one-step separation process. This one-step separation process can achieve high recycling efficiency from the extraction step, particularly for nickel. The recycling rate can exceed 80%, and in some cases, it can reach over 95%. Under optimized conditions, the recycling rate can be greater than 98%.

TABLE 4

| | Before | Aqueous Phase |
|---|---|---|
| | Extraction | 1st Extraction 10:1 |
| Element | (g/L) | (g/L) |
| Ni | 50.17 | 82.23 |
| Li | 9.16 | 8.63 |
| Co | 12.65 | 0.064 |
| Mn | 12.86 | 0.018 |
| Cu | 2.27 | 0.00078 |
| Fe | 0.26 | <0.00010 |
| Al | 1.23 | 0.025 |
| F | 1.42 | Not measured |
| P | 0.0053 | 0.015 |
| Ca | 0.16 | 0.055 |
| Mg | 0.043 | 0.012 |

Another nickel (Ni), cobalt (Co), and manganese (Mn) sulfate solution was extracted in three stages using the same batch of nickel-saponified C272 extract solution as in the previous examples, at a volume ratio of 4:1 organic-to-aqueous (O/A) for each stage. The pH of the solution from the first extraction was approximately 4 to 5. The aqueous phase from each stage was carried over to the subsequent stages. The organic phases were ultimately combined. The aqueous solution after the third extraction was filtered through a carbon filter before testing. The results are presented in Table 5. This suggests that the three-stage 4:1 O/A extraction provides sufficient separation of these metals from nickel, allowing for the precipitation of nickel hydroxide or similar forms with dopants or other incorporated elements depending on the product requirements, and the potential to achieve battery-grade product. Notably, the data demonstrate that under selected conditions, Co and Mn can be effectively separated from Ni, representing a single extractant (C272) separation process, although the extraction step can be separated into stages. The recycling rate can exceed 85%, and in some cases, it can reach over 95%. Under selected conditions, the recycling rate can be greater than 99%.

TABLE 5

| | Before | Aqueous Phase |
|---|---|---|
| | Extraction | 3rd Extraction of 4:1 |
| Element | (g/L) | (g/L) |
| Ni | 50.17 | 80.93 |
| Li | 9.16 | 8.64 |
| Co | 12.65 | 0.026 |
| Mn | 12.86 | 0.0044 |
| Cu | 2.27 | 0.00048 |
| Fe | 0.26 | <0.00010 |
| Al | 1.23 | 0.099 |
| F | 1.42 | 0.31 |
| P | 0.0053 | 0.012 |
| Ca | 0.16 | 0.042 |
| Mg | 0.043 | — |

### EXAMPLE CONCEPTUAL COMMERCIAL EMBODIMENTS

Some non-limiting specifics of some conceptual embodiments relating to commercialization are outlined in the following to provide further context for the general description above.

### Step 1—Black Mass Reduction Roast

Goal: Remove organic components, reduce high valent metal oxides to lower valence states to facilitate downstream extraction
Feedstock: Recycled Li-ion battery black mass containing oxides of Li, Ni, Mn, Co, along with Al, Cu, Fe (primarily metals), organics including polymers such as PVDF and electrolyte components
Purchased Raw Materials: Black mass
Chemistry: Thermal reduction of metals and organics

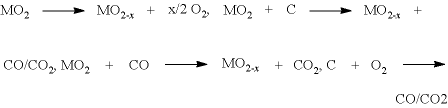

Conditions: N₂ atmosphere with low O₂ concentration, 650° C., 30 min residence time
Unit operations: Inert atmosphere furnace (continuous preferred), vent gas treatment (likely a wet scrubber using aq. NaOH)
Product: Mixture of reduced oxides of Li, Ni, Mn, Co, oxides and metallic Al, Cu, Fe, and carbonaceous material

### Step 2—Lithium Recovery

Goal: Recover Li from black mass as LiCO₃
Feedstock: Reduced black mass
Chemistry:
Leaching: H₂SO₄+LiOₓ→Li₂SO₄+H₂O (also remove Ca & Mg sulfates)
Ca, Mg removal: Ca,MgSO₄+adsorbent→adsorbed Ca, Mg+H₂SO₄
Precipitation: Li₂SO₄(aq)+NaOH/NaCO₃→LiCO₃(s)+Na₂SO₄(aq)
Carbonate/bicarbonate conversion: Li₂CO₃+H₂O+CO₂→2 LiHCO₃
Pyrolysis: 2 LiHCO₃→Li₂CO₃+H₂O+CO₂
Purchased Raw Materials:
Cone. H₂SO₄ (diluted to desired concentration), 50% aq. NaOH, solid NaCO₃, liquid CO₂
Conditions:
Leaching: 0.1-0.5 M H H₂SO₄, pH 6-7.5, ambient conditions
Ca, Mg removal: chelating ion exchange resin or other absorbent, ambient conditions, regenerate under acidic conditions.
Precipitation: ambient conditions
Thermal Decomposition: 100-150° C.
Carbonate/Bicarbonate Conversion: ambient conditions
Drying:
Grinding: air atmosphere
Unit Operations:
   Leaching: continuous
   Ca, Mg removal: Fixed bed adsorption
   Precipitation1: Stirred tank reactor
   Filtration::Batch or continuous; filter or centrifuge; type depends on solid characteristics
   Carbonate/bicarbonate conversion: stirred tank reactor
   Pyrolysis: Batch or continuous furnace
   Dryings: Batch or continuous; type depends on solids drying characteristics; possibly combined with pyrolysis
   Grinding: Batch or continuous (hammer mill, media mill, jet mill, etc.; type depends on feed and product characteristics)
Products: Li2CO3 (product), leached black mass (wet with aq. H₂SO₄ sent to step 3), Ca/Mg loaded adsorbent (to regeneration), filtrate (recycle or waste). Oven & dryer vent gases (to scrubber)

### Step 3: Leaching Ni, Co, Mn

Goal: Leach Ni, Co. and Mn as sulfates; separate solid carbonaceous material
Feedstock: H₂SO₄-wet black mass with Li removed
Chemistry: MOx₋₂+H₂SO₄+H₂O₂→MSO₄+H₂O
Purchased Raw Materials: Conc. H₂SO₄ (diluted to desired concentration), H₂O₂(note.: 50% H₂O₂. is typical concentration used in mining operations: 30-35% is used in food, pharmaceutical & cosmetic applications)
Conditions: Leaching @70° C., 5 hr residence time
Unit Operations:
   Leaching: fixed bed or slurry, batch or continuous
   filtration: batch or continuous filter or centrifuge depending on characteristics of solids (may want to wash filter cake)
Products: Aqueous solution of Ni, Co, and Mn sulfates containing Fe. Al, Cu impurities (to step 4), carbonaceous residue (solid waste)

### Step 4—Impurities Removal

Goal: Remove traces of Fe, Cu, and Al as well as residual Mg & Ca from metal sulfate solution
Feedstock: Metal sulfate solution from step 3
Chemistry:
   Cu removal: CuSO₄+Fe→Cu+FeSO₄/Fe₂(SO₄)₃
   Fe, Al removal: FeSO₃/Fe₂(SO₄)₃+Al₂(SO₄)₃+H₂O₂+NaOH—+Fe(OH)₃+2 Al(OH)₃+Na₂SO₄+H₂O
Purchased Raw Materials: Fe powder, 50% H₂O₂, 50% aq. NaOH
Unit Operations:
   Cu removal: stirred tank reactor
   Fe, Al removal: stirred tank reactor
   Filtration: batch or continuous filter or centrifuge, depending on characteristics of solids
Products: Purified metal sulfate solution (to step 5), Cu/Fe precipitate (waste or recovery), Fe/Al hydroxides (waste)

### Step 5—Ni and Co Recovery

Goal: Recover Ni as Ni(OH)₂ and Co as metal
Feedstock: Ni/Co sulfate solution
Chemistry:
   Cyanex 272 (Na, Ni, NH₄) saponification: C₁₆H₃₅O₂P+NaOH→C₁₆H₃₄O₂PNa+H₂O
   Ni/Cyanex 272 complexation: C₁₆H₃₄O₂PNa/C₁₆H₃₅O₂P+CoSO₄→(C₁₆H₃₄O₂)₂PCo+H₂SO₄/Na₂SO₄
   Co stripping: (C₁₆H₃₄O₂)₂PCo+H₂SO₄→CoSO₄+2 C₁₆H₃₅O₂P
   Ni recovery: NiSO₄+2 NaOH→Ni(OH)₂+Na₂SO₄
   Co recovery: Co²⁺+2e⁻→Co/H₂O→½O₂+2H⁺+2e⁻
Purchased Raw Materials: Cyanex 272, 50% NaOH, H₂SO₄

### Example Process Inputs

Feedstock: Black mass from Li-ion battery deconstruction
35% graphite, 28% Ni, 4% Li, 3% Co, 3% Mn, 4% Fe+Al+Cu, 4% residual electrolyte
Process Chemicals:
98% H₂SO₄ (diluted as needed)
50% H₂O₂
Liquid CO₂
36% HCI (diluted as needed)
50% NaOH/NaOH flake
Separation Agents
Utilities
DI water (produced on-site via ion exchange)
Electricity (converted to DC for Co electrowinning)
Roasting gas (96% N₂/4% O₂, produced on-site via membrane or PSA unit)

### Example Process Products

Primary Products
Li₂CO₃ powder
   Battery grade—99.5% minimum purity, 5-7 microns average particle size
Ni(OH)₂ powder
   cathode precursor
Co metal (electrowon cathode)
   99.8% minimum purity (similar to Co metal produced via electrodeposition)
Waste Products
Graphite cake
   Primarily from battery anodes; NiSO₄ & H₂O are primary other components
MnSO₄
   Relatively small amount; recovery may not be economical due to low market price but may be sold to Mn recovery specialist
Cu metal or Cu(OH)₂, Al(OH)₃, Fe(OH)₃
Solid wastes; landfill disposal or transfer to metal recovery firm
Na₂SO₃
   Byproduct of Ni(OH)₃ production; precipitated Na₂SO₄ is filtered and disposed of via landfill (low value material)
Aqueous waste
   Water generated in precipitation reactions and from filter cake ashes, ion exchange column regeneration effluent; disposed of via waste water treatment
Other waste
Separation Agent losses and decomposition products
Vent gas
Vent gas from roasting operation, Co electrodeposition, vessel vent streams disposed of in scrubbers and/or thermal oxidizers

### Further Inventive Concepts

A1. A method for recovering purified nickel from a recovered lithium ion battery material, the method comprising:
using precipitation and/or selective leaching, free of any solvent-solvent extractions, of an input aqueous solution to form a prepared solution having greater than about 90 weight %, of the nickel, cobalt and manganese from the input aqueous solution and having no more than about 15 mole % relative to total metal content of iron, copper and aluminum, wherein the input aqueous solution is prepared from recovered lithium ion battery material; and
performing a liquid-liquid extraction with the prepared solution to separate nickel from cobalt and magnesium to obtain a purified aqueous phase comprising at least 90% of the nickel from the input aqueous solution and no more than about 5% of the each of the cobalt and manganese from the input aqueous solution.

A2. The method of inventive concept A1 further comprising forming the input aqueous solution using sulfuric acid and an oxidizing agent to dissolve nickel, cobalt and manganese in a +2 oxidation state.

A3. The method of inventive concept A1 wherein selective leaching comprises dissolving lithium into an aqueous solution from the recovered lithium ion battery material with a suitable amount of sulfuric acid while retaining most of the nickel, cobalt and manganese in the solid mass.

A4. The method of inventive concept A1 wherein the precipitating comprises recovering copper from the input aqueous solution using iron powder to reduce the copper to form a precipitate and filtering the precipitate to isolate the reduced copper as metal.

A5. The method of inventive concept A1 wherein the precipitating comprises using an alkaline compound and an oxidizing agent to precipitate iron and aluminum as +3 oxidation state hydroxides.

A6. The method of inventive concept A1 wherein the performing a liquid-liquid extraction comprises mixing an aqueous phase with dissolved metal sulfate with an organic solvent, wherein the organic solvent has a density no greater than 0.975 g/mL, has a volume from about 0.1 times to about 50 times the aqueous volume, comprises hydrocarbons and wherein the organic phase comprises di-(2,4,4-trimethylpentyl) phosphinic acid from 30% to 70% hydroxyl saponified with alkali, ammonium, and/or nickel counter ions.

A7. The method of inventive concept A6 wherein the organic solvent comprises mineral oil, kerosene, sulphonated kerosene or a mixture thereof.

A8. The method of inventive concept A6 wherein the organic phase has a concentration of di-(2,4,4-trimethylpentyl) phosphinic acid from about 2 vol % to about 25 vol %.

A9. The method of inventive concept A6 wherein the di-(2,4,4-trimethylpentyl) phosphinic acid is 45% to 65% saponified.

A10. The method of inventive concept A9 wherein the saponification involves nickel+2 ions, NH₄⁺, sodium+1 ions or a mixture thereof.

A11. The method of inventive concept A6 wherein the organic phase volume is from about 0.5 times to about 20 times the aqueous volume.

A12. The method of inventive concept A1 the performing a liquid-liquid extraction comprises one or more stages performed using an input aqueous solution comprising lithium ions, nickel ions, cobalt ions and manganese ions as well as A1, Fe, Cu, Zn, Mg, and/or Ca ions.

A13. The method of inventive concept A12 wherein the number of stages is at least 2.

A14. The method of inventive concept A12 wherein the liquid-liquid extraction has one stage with continuous extraction.

A15. The method of inventive concept A12 wherein each stage comprises mixing an aqueous phase with dissolved metal sulfate with an organic solvent, wherein the organic solvent has a density no greater than 0.975 g/mL, has a volume from about 0.1 times to about 50 times the aqueous volume, comprises hydrocarbons and wherein the organic phase comprises di-(2,4,4-trimethylpentyl) phosphinic acid from 30% to 70% hydroxyl saponified with alkali, ammonium or nickel counter ions.

A16. The method of inventive concept A1 wherein the liquid-liquid extraction further comprises:
separating the organic phase from the aqueous phase to extract cobalt and manganese ions from the aqueous phase while maintaining nickel substantially in the aqueous phase.

A17. The method of inventive concept A16 further comprising:
collecting a purified aqueous phase comprising at least 90% of the nickel from the input aqueous solution and no more than about 5% of the each of the cobalt and manganese from the input aqueous solution.

A18. The method of inventive concept A17 further comprising precipitating nickel from the purified aqueous phase, wherein the nickel or the nickel-based hydroxide is in the battery grade and the nickel-based hydroxide is combined with newly added virgin or separately purified elements such as Co, Mn, Al or other elements in an amount from 1% to 50% with doping elements in amounts ranging from a few hundred ppm to a few percent by weight, and with impurity levels of less than 500 ppm by weight.

A19. The method of inventive concept A18 further comprising after precipitating nickel, precipitating lithium as a carboxylate.

A20. The method of inventive concept A16 further comprising stripping cobalt and manganese ions into an aqueous phase from loaded organic solvent and coprecipitating cobalt and manganese as hydroxides, carbonates or related compounds together or separately.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understood that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to expected uncertainties in the associated values as would be understood in the particular context by a person of ordinary skill in the art. A person of ordinary skill in the art is notified that the assertions above regarding the contemplation of subranges within explicit ranges are sincerely intended to provide explicit written description for the subranges, as clearly suggested, even though not explicitly written and that the subranges are not believed to change the character of the associated invention, although of course the specific values of parameters will certainly quantitatively change corresponding results obtained, which could influence patentability even though the basic character of the invention may not be changing, in view of the potential nature of the state of the art known or unknown at filing given that the inventiveness may follow from the factual details.

What is claimed is:

1. A method for separating nickel from an aqueous solution using an organic—aqueous extraction comprising:
performing one or more liquid-liquid extraction stages performed using an input aqueous solution comprising lithium ions, nickel ions, and cobalt ions and/or manganese ions, wherein each extraction stage comprises:
mixing an aqueous phase with dissolved metal sulfate with an organic solvent, wherein the organic solvent has a density no greater than 0.975 g/mL, has a volume from about 0.1 times to about 50 times the aqueous volume, and wherein the organic phase comprises di-(2,4,4-trimethylpentyl) phosphinic acid from 30% to 70% hydroxyl saponified with alkali, NH₄⁺ or nickel counter ions; and
separating the organic phase from the aqueous phase to extract cobalt ions and manganese ions from the aqueous phase while maintaining nickel substantially in the aqueous phase; and
collecting a purified aqueous phase comprising at least 90% of the nickel from the input aqueous solution and no more than about 5% of the each of the cobalt and manganese from the input aqueous solution and other elements, except Li⁺, Na⁺, NH₄⁺.

2. The method of claim 1 wherein the organic solvent comprises mineral oils, kerosene, sulphonated kerosene or mixtures thereof.

3. The method of claim 1 wherein the organic phase has a concentration of di-(2,4,4-trimethylpentyl) phosphinic acid from about 2 vol % to about 25 vol %.

4. The method of claim 1 wherein the di-(2,4,4-trimethylpentyl) phosphinic acid is 45% to 65% saponified.

5. The method of claim 4 wherein the saponification involves nickel+2 ions, and/or sodium +1 ions, and/or NH₄⁺ ions.

6. The method of claim 1 wherein the organic phase volume is from about 0.5 times to about 20 times the aqueous volume.

7. The method of claim 1 wherein the number of stages is at least 2.

8. The method of claim 1 wherein the number of stages is one.

9. The method of claim 1 wherein the input aqueous solution comprises at least about 50 wt % nickel relative to the total metal in the solution.

10. The method of claim 1 wherein the input aqueous solution is obtained from a mass of material from retired lithium ion batteries.

11. The method of claim 1 wherein the input aqueous solution is obtained from a mass of material from nickel ore concentrates.

12. The method of claim 10 wherein the input aqueous solution is formed by a process comprising adding sulfuric acid to leach metal from the recovered battery mass to form a leachate.

13. The method of claim 12 wherein a reducing agent is added in conjunction with the leaching process to generate metal ions in the +2 oxidation state.

14. The method of claim 12 wherein copper, aluminum and iron are removed from the leachate by increasing the pH.

15. The method of claim 12 wherein copper metal is recovered from the leachate using iron powder as a reducing agent, and iron and aluminum are precipitated as hydroxides using an oxidizing agent and an alkaline additive, while leaving nickel, manganese and cobalt in solution.

16. The method of claim 1 further comprising precipitating the nickel to obtain nickel hydroxide precipitate, wherein the nickel or the nickel-based hydroxide is in the battery grade and the nickel-based hydroxide is combined with newly added virgin or separately purified elements such as Co, Mn, Al or other elements in an amount from 1% to 50% with doping elements in amounts ranging from a few hundred ppm to a few percent by weight, and with impurity levels of less than 500 ppm by weight.

17. The method of claim 16 further comprising recovering lithium following precipitation of the nickel.

18. The method of claim 16 further comprising after precipitating nickel, precipitating lithium as a carboxylate.

19. The method of claim 1 further comprising recovering manganese and cobalt from the organic phase.

20. The method of claim 1 wherein the separating step further extracts Al, Fe, Cu, Zn, Mg, and/or Ca ions into the organic phase.
